(19) United States
(12) Patent Application Publication
(10) Pub. No.: US 2016/0165079 A1
(43) Pub. Date: Jun. 9, 2016

(54) INFORMATION PROCESSING APPARATUS AND INFORMATION PROCESSING METHOD

(71) Applicant: Takuroh FUJIOKA, Kanagawa (JP)

(72) Inventor: Takuroh FUJIOKA, Kanagawa (JP)

(21) Appl. No.: 14/955,250

(22) Filed: Dec. 1, 2015

(30) Foreign Application Priority Data
Dec. 5, 2014 (JP) 2014-247323
Apr. 30, 2015 (JP) 2015-093465

(51) Int. Cl. H04N 1/00; G06F 3/12; G10L 15/26

(52) U.S. Cl. CPC H04N 1/00464; G10L 15/26; H04N 1/0044; H04N 1/00307; H04N 1/00222; H04N 1/00411; G06F 3/1273; G06F 3/1246; G06F 3/1247; H04N 2201/0094

(57) ABSTRACT

A disclosed information processing apparatus performing communications with a terminal via a network, includes a receiver configured to receive first audio data from a predetermined terminal, a converter configured to convert the first audio data into first character data, a generator configured to generate intermediate language data corresponding to a print language interpretable by the information processing apparatus based on the first character data, and a transmitter configured to transmit the intermediate language data to the predetermined terminal to allow another information processing apparatus to utilize the intermediate language data.

### BACKGROUND OF THE INVENTION

1. Field of the Invention

The disclosures herein generally relate to an information processing apparatus and an information processing method.

2. Description of the Related Art

Wide spread IC recorders, smartphones, and tablet terminals have made many contributions to environments for facilitating audio data entry. In addition, a text entry technology by converting entered audio data into character data has already been achieved and applied to an audio information management technology and a display technology in a related art.

For example, Japanese Laid-open Patent Publication No. 2010-044666 (Patent Document 1) discloses examples of the audio information management technology and the display technology to automatically acquire electronic information having desired added values (e.g., title, item classification, keywords, and dates) from the recorded audio information and manage the acquired electronic information based on the added values.

However, the above related art audio information management technology and the display technology that are aimed at displaying the character data converted from the entered audio data on a screen of mobile terminals such as smartphones or personal computers (PCs), have not sufficiently anticipated converting audio data into character data to print the character data converted from the audio data.

### RELATED ART DOCUMENT

### Patent Document

Patent Document 1: Japanese Laid-open Patent Publication No. 2010-044666

### SUMMARY OF THE INVENTION

Accordingly, it is a general object in one embodiment of the present invention to provide a technology capable of converting audio data into character data to print the character data converted from the audio data that substantially obviates one or more problems caused by the limitations and disadvantages of the related art, and facilitate usage of the technologies.

According to an aspect of embodiments, there is provided an information processing apparatus performing communications with a terminal via a network. The information processing apparatus includes a receiver configured to receive first audio data from a predetermined terminal; a converter configured to convert the first audio data into first character data; a generator configured to generate intermediate language data corresponding to a print language interpretable by the information processing apparatus based on the first character data; and a transmitter configured to transmit the intermediate language data to the predetermined terminal to allow another information processing apparatus to utilize the intermediate language data.

Other objects, features and advantages of the present invention will become more apparent from the following detailed description when read in conjunction with the accompanying drawings.

### BRIEF DESCRIPTION OF THE DRAWINGS

FIG. 1 is a block diagram illustrating an example of a connecting configuration of an information processing apparatus according to an embodiment;

FIG. 2 is a diagram illustrating a print process of a generally-used information processing apparatus;

FIG. 3 is a diagram illustrating an example of a hardware configuration of the information processing apparatus according to the embodiment;

FIG. 4 is a diagram illustrating an example of a software configuration of the information processing apparatus according to the embodiment;

FIG. 5 is a flowchart illustrating an example of a process of the information processing apparatus from generating intermediate language data to transmitting the generated intermediate language data to a terminal;

FIG. 6 is a diagram illustrating an example of an operations panel that displays file names of audio data;

FIG. 7 is a diagram illustrating a process of transmitting the generated intermediate language data to the terminal;

FIG. 8 is a diagram illustrating a process from generating the intermediate language data selected by a user to transmitting the generated intermediate language data to the terminal;

FIG. 9 is a flowchart illustrating an example of a process of the information processing apparatus from receiving the intermediate language data from the terminal to storing the received intermediate language data;

FIG. 10 is a diagram illustrating a specific example of a process of comparing intermediate language data sets received by the information processing apparatus from the terminal;

FIG. 11 is a flowchart illustrating an example of a process of the information processing apparatus from editing the intermediate language data to printing the edited intermediate language data;

FIGS. 12A and 12B are diagrams illustrating examples of screens for selecting a print form and print fonts;

FIGS. 13A to 13C are examples of screens for displaying a print image before being edited, while being edited, and after being edited;

FIG. 14 is a flowchart illustrating a modified example of a process of the information processing apparatus to print the intermediate language data; and

FIG. 15 is a flowchart illustrating an example of a process associated with a process of the information processing apparatus to report completion of the printing and a print log to the terminal.

### DETAILED DESCRIPTION OF THE PREFERRED EMBODIMENTS

In the following, an illustration is given of an embodiment with reference to the accompanying drawings. In the drawings, identical components or units are provided with the same reference numbers to omit duplicated illustrations.

### Outline

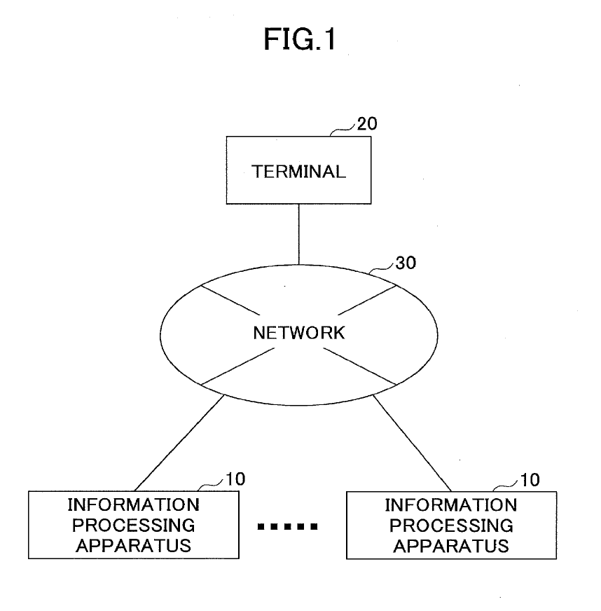

FIG. 1 is a block diagram illustrating an example of a connecting configuration of an information processing apparatus according to an embodiment. The information processing apparatus 10 according to an embodiment may be connected to a terminal 20 via a network 30 such as a wireless local area network (LAN) to communicate with the terminal 20.

The information processing apparatus 10 may be a multifunction peripheral (MFP) having two or more functions such as a printer function, a copier function, a scanner function, and a facsimile function. The information processing apparatus 10 is not limited to the MFP, but may be any information processing apparatus that includes a printer function.

The terminal 20 may be a mobile phone, a smartphone, and a tablet terminal. The terminal 20 is not limited to the above examples but may be any terminal capable of communicating with the information processing apparatus 10.

In addition, the information processing apparatus 10 may be configured to authenticate the terminal 20 through short-range communications such as near field communications (NFC). With this configuration, the information processing apparatus 10 is able to give an access right merely to the terminal 20 having access authorization to provide security such as information leakage prevention.

Next, a description is given of an outline of operations of the information processing apparatus 10 according to the embodiment. Initially, a user connects the terminal 20 to the information processing apparatus 10. When the terminal 20 is connected to the information processing apparatus 10, the information processing apparatus 10 displays file names of audio data saved in the terminal 20 on a display to encourage the user to select desired audio data.

The information processing apparatus 10 downloads the audio data selected by the user from the terminal 20. Subsequently, the information processing apparatus 10 converts the downloaded audio data into character data to generate intermediate language data corresponding to a page description language (PDL) disposed in the information processing apparatus 10.

Subsequently, the information processing apparatus 10 generates a print image from the generated intermediate language data to display a preview on the display of the information processing apparatus 10, and optionally receives editing operations from the user. Accordingly, the user may be able to optionally edit the print image such as changing a print form, and changing a style or color of the characters while browsing the print image displayed on the display. Subsequently, the information processing apparatus 10 receives an instruction from the user to print the intermediate language data.

The information processing apparatus 10 may also be able to transmit (upload) the generated intermediate language data to the terminal 20 in order to allow another information processing apparatus 10 to print the generated intermediate language data. Accordingly, the user may be able to connect the terminal 20 storing the intermediate language file to another information processing apparatus 10 so as to edit and print the intermediate language data.

In the following, a description is given of the PDL and intermediate language data. The PDL is a computer language for giving drawing instructions to the image forming apparatuses such as printers and MFPs. The PDL specifies a print position of the character and a character type with commands, and allows the image forming apparatus to translate the specified commands to print the translated commands. For example, a high functionality language such as a postscript (hereinafter referred to as “PS”) (registered trademark) may be able to specify the print position of the character with a command without any interruption.

The formats of the commands may vary with the languages. There are two types of formats: the first type is a descriptive language such as PS and ART with which the commands are described in alphanumeric characters and symbols, and the second type is a non-descriptive language such as a printer command language (PCL) and LBP image processing system (LIPS) with which the commands are described in non-printable characters combined with strings. Further, examples of the PDL include ART, LIPS, Epson standard code for printers (ESC/P), and refined printing command stream (RPCS) uniquely developed by the manufacturers of image forming apparatuses, and the PCL and PS that serve as the international de facto standard.

The intermediate language data are program data having source codes, each line of which is executed to implement a process content described in the intermediate language data. Accordingly, the print position or the character type of the intermediate language data may be specified similar to those of the data described according to the PDL. Note that the intermediate language data may include data that depend on models of the informing apparatuses, which may differ from the data described according to the PDL. The intermediate language data are executed by an interpreter program; however, the interpreter program differs for each of the PDLs, and needs to have a corresponding one of intermediate language data sets in association with the PDLs. On the other hand, the intermediate language data are not actually printing image data, that is, rasterized data. Thus, the intermediate language data have advantages such as the data amount itself being small and not being affected by the resolution of the image forming apparatus itself.

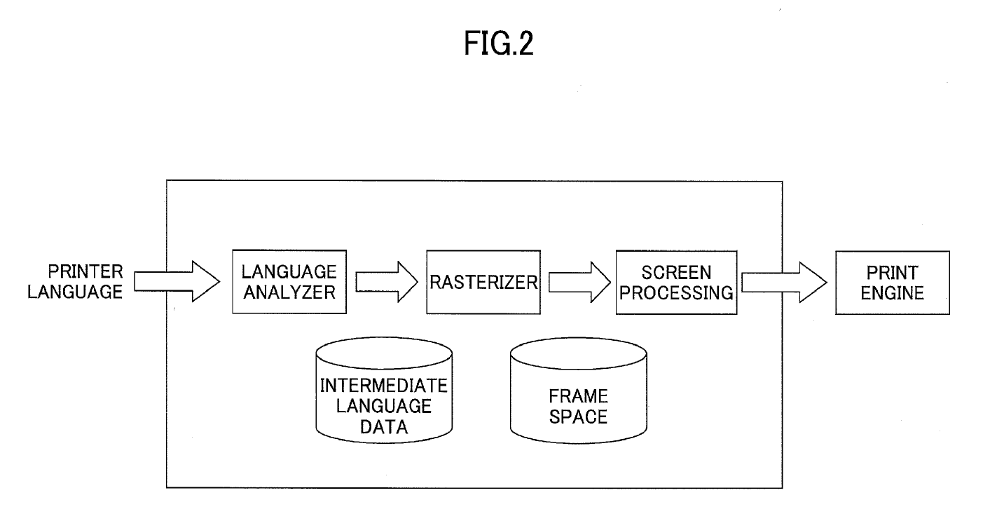

FIG. 2 is a diagram illustrating a print process of a generally-used information processing apparatus. The generally-used information processing apparatus is configured to receive print data in a printer language (PDL) format from a personal computer (PC), and translate the received data by a language analyzer to generate intermediate language data. The intermediate language data are rasterized by a rasterizer, drawing-processed in a frame space of a memory, then screen-processed, and output in a print engine.

In general, a printer driver installed in the PC selects print data corresponding to the PDL. However, the information processing apparatus 10 according to the embodiment directly prints the character data converted from the audio data without being mediated by the printer driver. Accordingly, when there are two or more PDLs that may be translated by the information processing apparatus 10, the information processing apparatus 10 may generate the intermediate language data sets corresponding to the plural PDLs, and subsequently allow the user to select the PDL for use in printing from the PDLs.

### Hardware Configuration

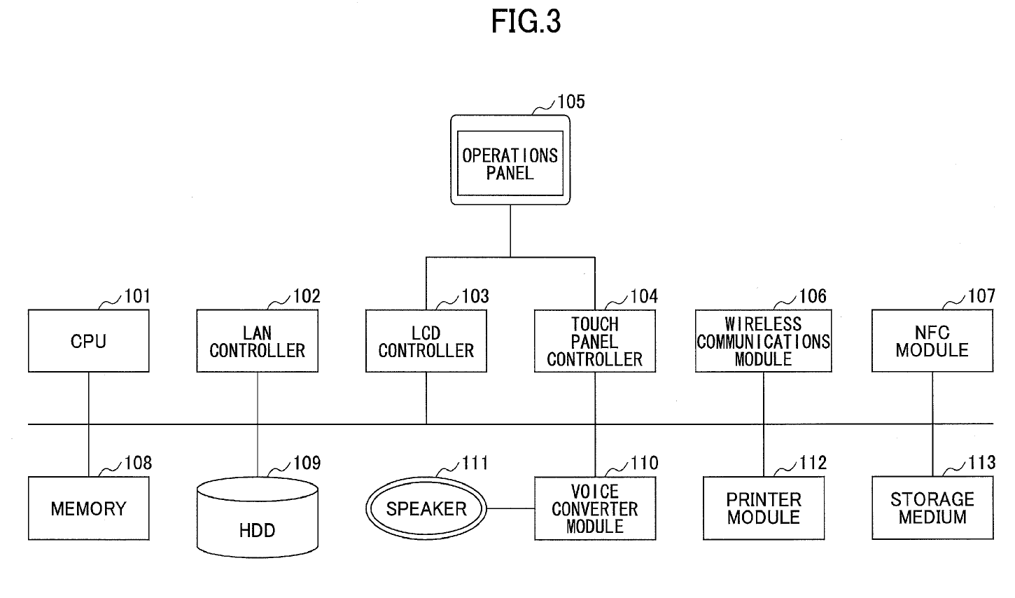

FIG. 3 is a diagram illustrating an example of a hardware configuration of the information processing apparatus according to the embodiment. The information processing apparatus 10 according to the embodiment includes a CPU 101, a LAN controller 102, a liquid crystal display (LCD) controller 103, a touch panel controller 104, an operations panel 105, a wireless communications module 106, a near field communications (NFC) module 107, a memory 108, a hard disk drive (HDD) 109, a voice converter module 110, a speaker 111, and a printer module 112. The information processing apparatus 10 according to the embodiment may also include a removable storage medium 113.

The CPU 101 serves as a processor configured to perform overall control of the information processing apparatus 10. The LAN controller 102 is configured to connect to the network 30 such as the LAN or a wide area network (WAN) to transmit data and to receive data from a server or the terminal. The LCD controller 103 serves as an image data transfer module configured to transfer image data loaded in the memory 108 to be displayed on the operations panel 105 according to the resolution of the operations panel 105 and a line scanning period.

The touch panel controller 104 is configured to detect a touched position on the touch panel built in the operations panel 105, and report the detected position to a program executing a predetermined operation. The operations panel 105 serves as an interface having a display to display menus or thumbnails to the user and the touch panel to receive operations from the user. The display generally employs a liquid crystal display; however, the display may be a cathode ray tube (CRT), an organic EL display, a SED (surface-conduction electron-emitter display), and electronic paper.

The wireless communications module 106 is configured to perform data communications with the terminal 20 or the like via the wireless communications. The wireless communications system may be a wireless LAN, but may be other systems. The NFC module 107 is configured to perform data communications with the terminal 20 or the like via near field wireless communications compliant with the NFC standards. The memory 108 is configured to hold programs and various types of data for operating the information processing apparatus 10. Further, the memory 108 is also configured to serve as a storage area for holding the programs stored in the HDD 109 or in the storage medium 113, and a work area of the loaded programs.

The HDD 109 is a nonvolatile storage and configured to store programs and various types of data for operating the information processing apparatus 10. Note that the HDD 109 may be a nonvolatile memory or a solid state drive (SSD). The voice converter module 110 is configured to convert digital audio data to analog sound pressure data for outputting the audio data as sound from the speaker 111. The speaker 111 is configured to output sound. The printer module 112 is hardware for printing print data on a print sheet. The storage medium 113 is a non-transitory storage medium 113 configured to store programs or the like. Examples of the storage medium 113 include a magnetic storage medium, an optical disk, a magneto-optical storage medium, and a nonvolatile semiconductor memory.

### Software Configuration

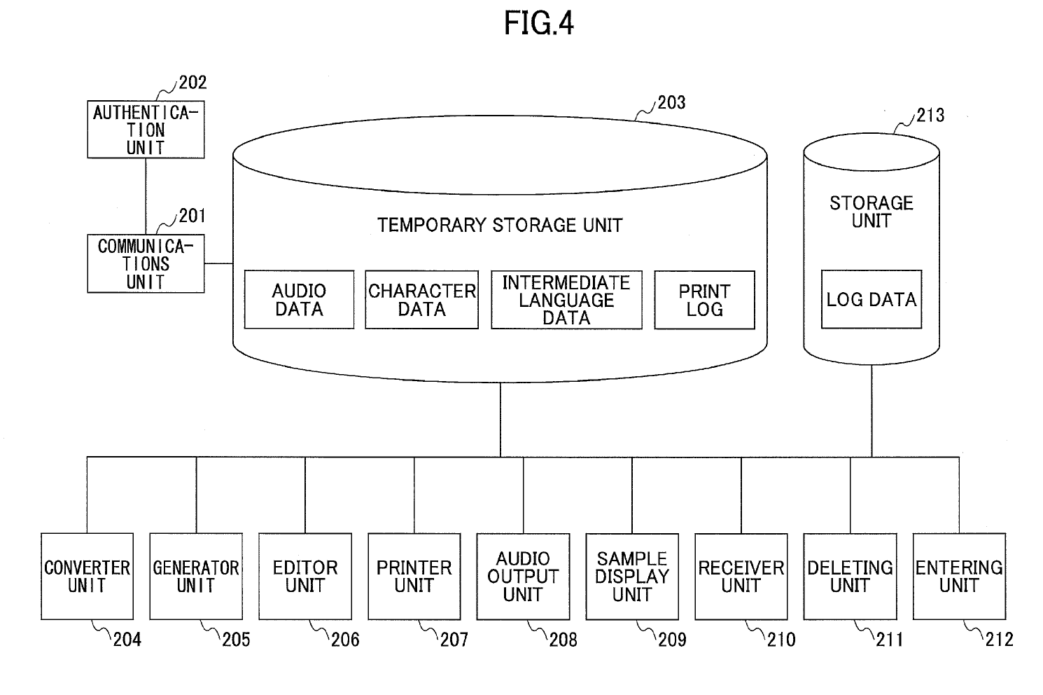

FIG. 4 is a diagram illustrating an example of a software configuration of the information processing apparatus according to the embodiment. The information processing apparatus 10 according to the embodiment includes a communications unit 201, a authentication unit 202, a temporary storage unit 203, a converter unit 204, a generator unit 205, an editor unit 206, a printer unit 207, an audio output unit 208, a sample display unit 209, a receiver unit 210, a deleting unit 211, an entering unit 212, and a storage unit 213. The above components or units may be implemented by one or more programs installed in the information processing apparatus 10 that causes the CPU 101 to execute processes.

The communications unit 201 is configured to perform communications with the terminal 20, a server, or the like via the LAN controller 102 or the wireless communications module 106.

The communications unit 201 is configured to store the data received from the terminal 20 or the server in the temporary storage unit 203, and transmit the data acquired from the temporary storage unit 203 to the terminal 20 or the server.

The authentication unit 202 is configured to read identification information from the terminal 20 via the NFC module 107, and authenticate the terminal 20 by matching the read identification information and identification information preregistered in the memory 108.

The temporary storage unit 203 may be implemented by utilizing a storage device and the like that are connected, for example, to the memory 108 of the information processing apparatus 10 via the network 30. The temporary storage unit 203 is configured to store audio data, character data, and intermediate language data.

The audio data are data recording voice and other sound, an example of which may be voice and other sound of conversations in a conference. The format or file size of the audio data is not specifically restricted. The character data are data converted from conversation or the like included in the audio data into characters. The character data may, for example, include hiragana, katakana, kanji, and the alphanumeric characters; however, the characters to be used are not specifically restricted. Further, the format of the character data is not specifically restricted.

The converter unit 204 is configured to convert voice and other sound included in the audio data into characters to generate character data. The process of converting voice and other sound into characters may be performed by the converter unit 204 itself, or may be performed by utilizing the API provided by a cloud service. Further, the converter unit 204 is configured to convert character data into audio data. In this case, the conversion process may also be performed by the converter unit 204, or performed by utilizing the API provided by the cloud service or the like.

The generator unit 205 is configured to generate from the character data intermediate language data corresponding to the PDL that may be translated by the information processing apparatus 10. The generator unit 205 is also configured to extract a character data part from the intermediate language data to generate the character data.

The editor unit 206 is configured to follow instructions from the user to edit the intermediate language data stored in the temporary storage unit 203 such as deleting a string, changing the color of the characters, and enlarging or reducing the characters. When the editor unit 206 completes editing by following the instructions from the user, the temporary storage unit 203 stores the edited intermediate language data.

The printer unit 207 is configured to read the intermediate language data stored in the temporary unit 203, rasterize the read intermediate language data, and subsequently print on a print sheet the rasterized intermediate language data by utilizing the printer module 112. In addition, the printer unit 207 is configured to generate print log data (hereinafter called a “print log”) after completion of printing the intermediate language data.

The audio output unit 208 is configured to read the audio data stored in the temporary storage unit 203, and control the voice converter module 110 to output the audio data from the speaker 111.

The sample display unit 209 is configured to generate a print image of the intermediate language data stored in the temporary storage unit 203 on the operations panel 105. Further, the sample display unit 209 is configured to read form data, print fonts and the intermediate language data, overlay the form data, print fonts and the intermediate language data to generate print data.

The receiver unit 210 is configured to display an operations screen on the operations panel 105, and receive instructions from the user via the operations panel 105.

The deleting unit 211 is configured to delete a print log and various types of data in association with the print log from the temporary storage unit 203.

The entering unit 212 is configured to perform an encryption process and a compression process on the print log and various types of data in association with the print log stored in the temporary storage unit 203, and enter the encrypted and compressed print log and various types of data in the storage unit 213. Further, the entering unit 212 is configured to optionally delete old print logs, and various types of data in association with the old print logs stored in the storage unit 213.

The storage unit 213 may be implemented by utilizing a storage device and the like that are connected, for example, to the HDD 109 or the information processing apparatus 10 via the network 30. The storage unit 213 is configured to store the print log and various types of data in association with the print log.

### Process Procedure

Next, a description is given of a process performed by the information processing apparatus 10 according to the embodiment. Initially, a description is given of a process of the information processing apparatus 10 including receiving audio data from the terminal 20, generating intermediate language data based on the audio data, and transmitting the generated intermediate language data to the terminal 20.

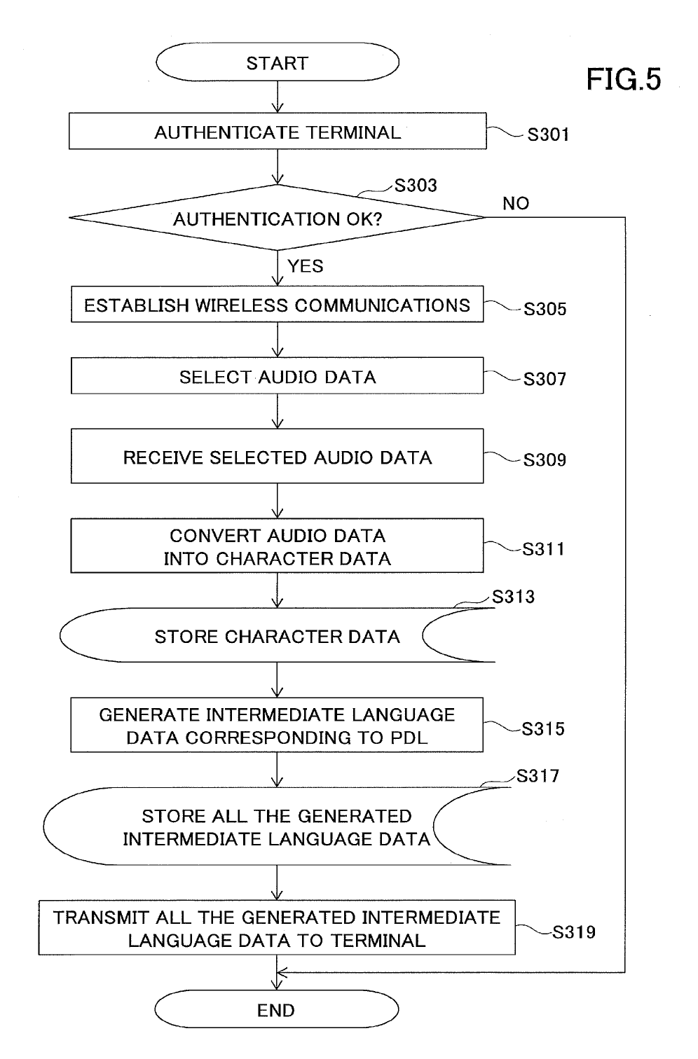

FIG. 5 is a flowchart illustrating a process of the information processing apparatus from generating intermediate language data to transmitting the generated intermediate language data to a terminal.

In step S301, the authentication unit 202 reads identification information from the terminal 20 disposed on the NFC module 107, and matches the read identification information and identification information preregistered in the memory 108 to perform authentication as to whether the terminal 20 is authorized to have an access to the information processing apparatus 10. When the authentication is successful (authorized), step S305 is processed, whereas the authentication is not successful (unauthorized), the process ends.

In step S305, the communications unit 201 establishes communications with the terminal 20 via the wireless communications module 106. The communications unit 201 may, for example, establish communications with the terminal 20 via a wireless communications system such as IEEE 802.11a, IEEE 802.11g, and IEEE 802.11n, or via a wireless communications system based on the Wi-Fi Direct standards. Further, the communications unit 201 may also establish communications with the terminal 20 via a wireless communications system such as 3G, long term evolution (LTE), or the like. The communications unit 201 may employ any types of communications system insofar as the information processing apparatus 10 is capable of performing communications with the terminal 20.

In step S307, the communications unit 201 receives from the terminal 20 file names of the audio data saved in the terminal 20. The receiver unit 210 displays the received file names on the operations panel 105, and receives from the user a selected result of the audio data to be acquired in the information processing apparatus 10.

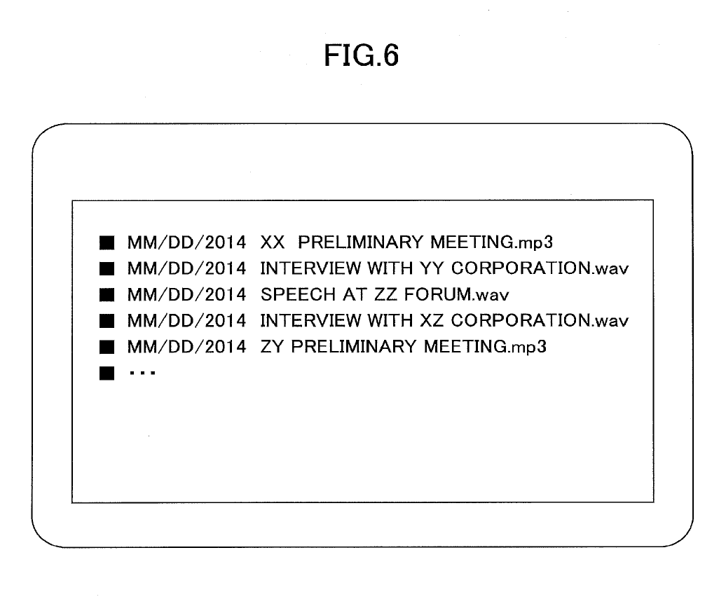

FIG. 6 is a diagram illustrating an example of an operations panel that displays file names of audio data. The operations panel 105 displays a list of time and dates, and file names of the generated audio data. The user may be able to select the audio data to be acquired from the terminal 20 by operating the operations panel 105.

The subsequent illustration is given below by referring back to FIG. 5.

In step S309, the communications unit 201 receives (downloads) from the terminal 20 the audio data selected in step S307. The communications unit 201 stores the downloaded audio data in the temporary storage unit 203.

In step S311, the converter unit 204 performs a sound recognition process on the audio data to convert the audio data into character data. Note that the converter unit 204 may convert the audio data into the character data by accessing an external cloud server or the like via the communications unit 201 to utilize the API provided from a service provider.

In step S313, the converter unit 204 stores the converted character data in the temporary storage unit 203. Note that the converter unit 204 stores the generated character data in the temporary storage unit 203 so as to identify the audio data in association with the generated character data. For example, the converter unit 204 may store the generated character data in the temporary storage unit 203 such that parts of the file names of the audio data excluding extensions match parts of the file names of the character data excluding extensions. The converter unit 204 may store the generated character data in the temporary storage unit 203 by any methods insofar as the generated character data are identifiable by the audio data in association with the character data.

In step S315, the generator unit 205 generates from the character data intermediate language data corresponding to the PDL that may be translated by the information processing apparatus 10.

Note that the intermediate language data generated by the information processing apparatus 10 are not necessarily processed by other information processing apparatuses 10. This is because the interpretable PDLs vary with models of the information processing apparatuses 10. Hence, the generator unit 205 may generate the intermediate language data sets corresponding to all the PDLs interpretable by the information processing apparatus 10 itself so as to increase the possibility for other information processing apparatuses 10 to process the intermediate language data.

Further, in order to reduce the processing load of the information processing apparatus 10 itself or reduce the memory usage of the terminal 20 to which the intermediate language data are uploaded, the generator unit 205 may be configured to generate the intermediate language data corresponding to a part of or any one of the PDLs instead of generating the intermediate language data sets corresponding to all the PDLs interpretable by the information processing apparatus 10 itself. In this case, the generator unit 205 may be configured to select a PDL that follows a de facto standard, or may be configured to allow the user to select a desired one of the PDLs. In addition, the generator unit 205 may be configured to select the PDL interpretable by the information processing apparatus 10 itself from the PDLs corresponding to the intermediate language data already stored in the terminal 20 connected to the information processing apparatus 10.

Further, the receiver unit 210 may be configured to display on the operations panel 105 a list of all the PDLs interpretable by the information processing apparatus 10 itself to allow the user to select a desired one of the PDLs, and the generator unit 205 may be configured to generate the intermediate language data corresponding to the PDL selected by the user.

In step S317, the generator unit 205 temporarily stores the intermediate language data generated in step S315 in the temporary storage unit 203. Note that the generator unit 205 stores the generated intermediate language data in the temporary storage unit 203 so as to identify the audio data in association with the generated intermediate language data. For example, the generator unit 205 may store the generated intermediate language data in the temporary storage unit 203 such that parts of the file names of the audio data excluding extensions match parts of the file names of the intermediate language data excluding extensions. The generator unit 205 may store the generated intermediate language data in the temporary storage unit 203 by any methods insofar as the generated intermediate language data are identifiable by the audio data in association with the generated intermediate language data.

In step S319, the communications unit 201 reads (retrieves) the intermediate language data generated in step S315 from the temporary storage unit 203, and transmits the read intermediate language data to the terminal 20.

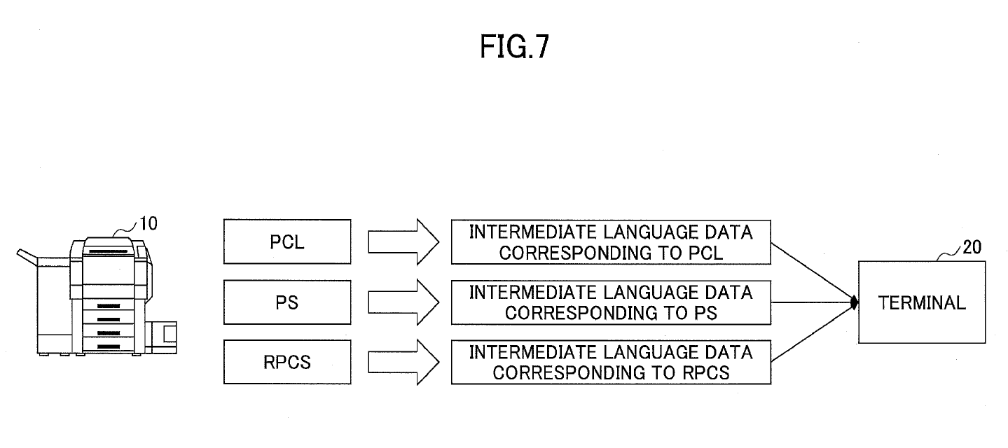

FIG. 7 is a diagram illustrating a process of transmitting the generated intermediate language data to the terminal. The example of FIG. 7 illustrates a process of generating the intermediate language data sets corresponding to all the PDLs interpretable by the information processing apparatus 10 and transmitting the generated intermediate language data to the terminal 20. In FIG. 7, “PCL”, “PS”, and “RPCS” indicate respective PDLs interpretable by the information processing apparatus 10. That is, the information processing apparatus 10 is configured to generate the intermediate language data corresponding to the PCL, the intermediate language data corresponding to the PS, and the intermediate language data corresponding to the RPCS, and transmit (upload) those three intermediate language data sets to the terminal 20.

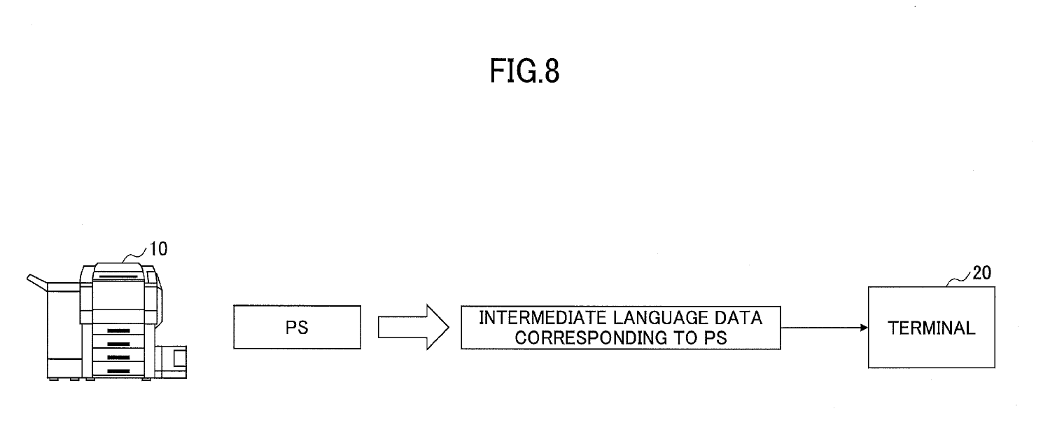

FIG. 8 is a diagram illustrating a process from generating the intermediate language data selected by a user to transmitting the generated intermediate language data to the terminal. The example of FIG. 8 illustrates a process of generating the intermediate language data corresponding to the PDL “PS” selected by the user and transmitting (uploading) the generated intermediate language data to the terminal 20.

The description above has illustrated a process of receiving the audio data from the terminal 20, generating the intermediate language data based on the audio data, and transmitting the generated intermediate language data to the terminal 20.

Next, a description is given of a process from receiving the intermediate language data from the terminal 20 to storing the received intermediate language data in the temporary storage unit 203 of the information processing apparatus 10. This process may allow the user to move the intermediate language data to another information processing apparatus differing from the information processing apparatus that has generated the intermediate language data, and allow the user to continue to perform an editing or printing process via the other information processing apparatus.

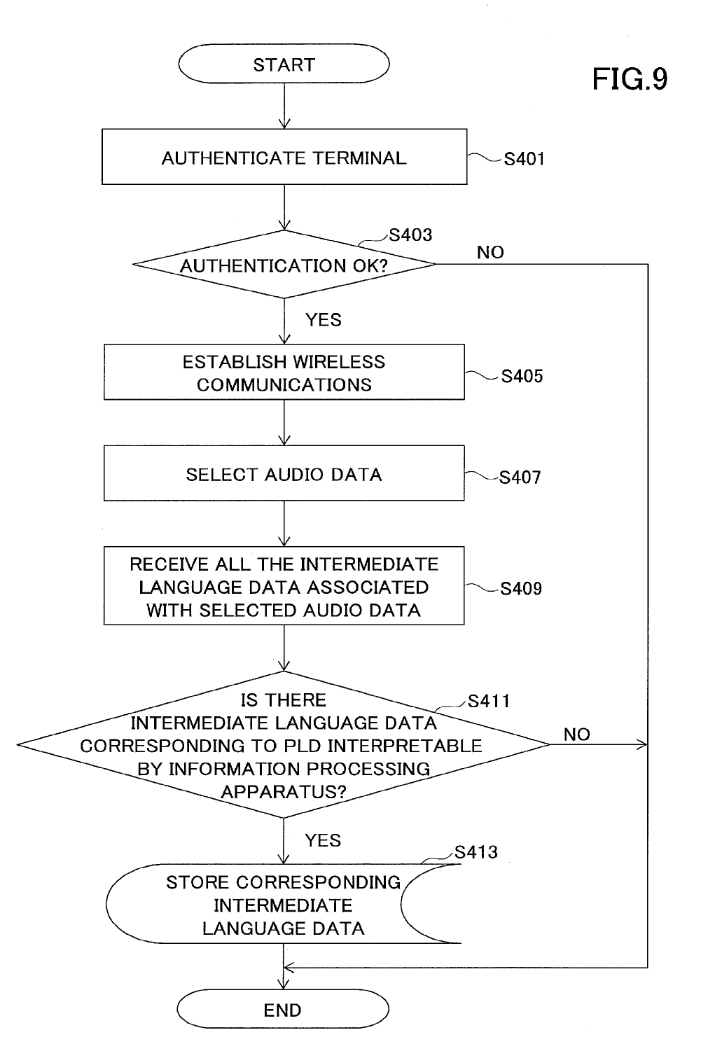

FIG. 9 is a flowchart illustrating a process of the information processing apparatus from receiving the intermediate language data from the terminal to storing the received intermediate language data.

Steps S401 to S407 are identical to steps S301 to S307 illustrated in FIG. 5, and a duplicated illustration is thus omitted from the specification.

In step S409, the communications unit 201 receives from the terminal 20 all the intermediate language data in association with the audio data selected via the operations panel 105.

In step S411, the communications unit 201 verifies whether there is intermediate language data corresponding to the PDL interpretable by the information processing apparatus 10 among all the intermediate language data received in step S409. When the intermediate language data corresponding to the PDL interpretable by the information processing apparatus 10 are found, step S413 is processed, whereas when such intermediate language data are not found, the process ends.

In step S413, the communications unit 201 stores all the intermediate language data sets corresponding to the PDLs interpretable by the information processing apparatus 10 in the temporary storage unit 203. Note that the temporary storage unit 203 also records all the intermediate language data sets stored in step S413 being the data received from the terminal 20.

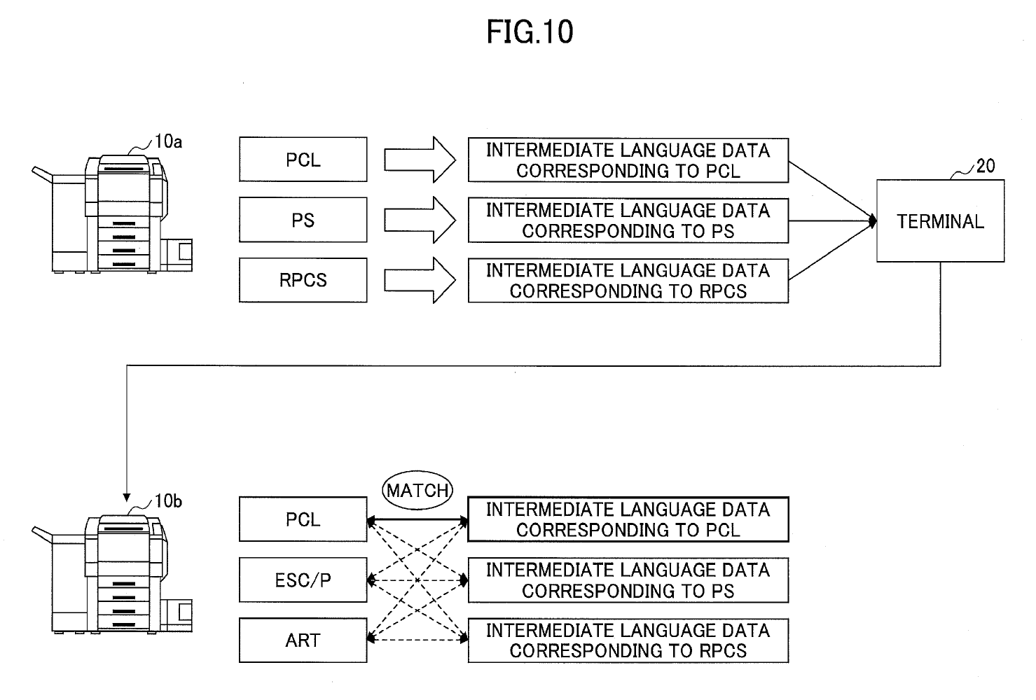

FIG. 10 is a diagram illustrating a specific example of a process of comparing intermediate language data sets received by the information processing apparatus from the terminal. An information processing apparatus 10a and an information processing apparatus 10b represent the information processing apparatuses differing from each other. The information processing apparatus 10a is configured to translate the PDLs “PCL”, “PS”, and “RPCS”, whereas the information processing apparatus 10b is configured to translate the PDLs “PCL”, “ESC/P”, “ART”.

The generator unit 205 of the information processing apparatus 10a is configured to generate the intermediate language data sets corresponding to the PDLs “PCL”, “PS”, and “RPCS”, and transmit the generated intermediate language data sets to the terminal 20. The terminal 20 is configured to store the received intermediate language data sets. Subsequently, the terminal 20 that has stored the intermediate language data sets is connected to the information processing apparatus 10b. The communications unit 201 of the information processing apparatus 10b is configured to receive the intermediate language data sets corresponding to the PDLs “PCL”, “PS”, and “RPCS” from the terminal 20.

Note that the information processing apparatus 10b is configured to translate only the PDL “PCL” among the PDLs corresponding to the intermediate language data sets received from the terminal 20. Hence, the communications unit 201 of the information processing apparatus 10b is configured to store the intermediate language data only corresponding to the PDL “PCL” in the temporary storage unit 203.

The description given above has illustrated the process from receiving the intermediate language data from the terminal 20 to storing the received intermediate language data in the temporary storage unit 203 of the information processing apparatus 10.

Next, a description is given of a process from displaying (previewing) print images of the intermediate language data stored in the temporary storage unit 203 to receiving and editing operation to print the images. Note that the intermediate language data may be generated by the information processing apparatus 10, or may be generated by another information processing apparatus 10 (i.e., the intermediate language data received from the terminal 20).

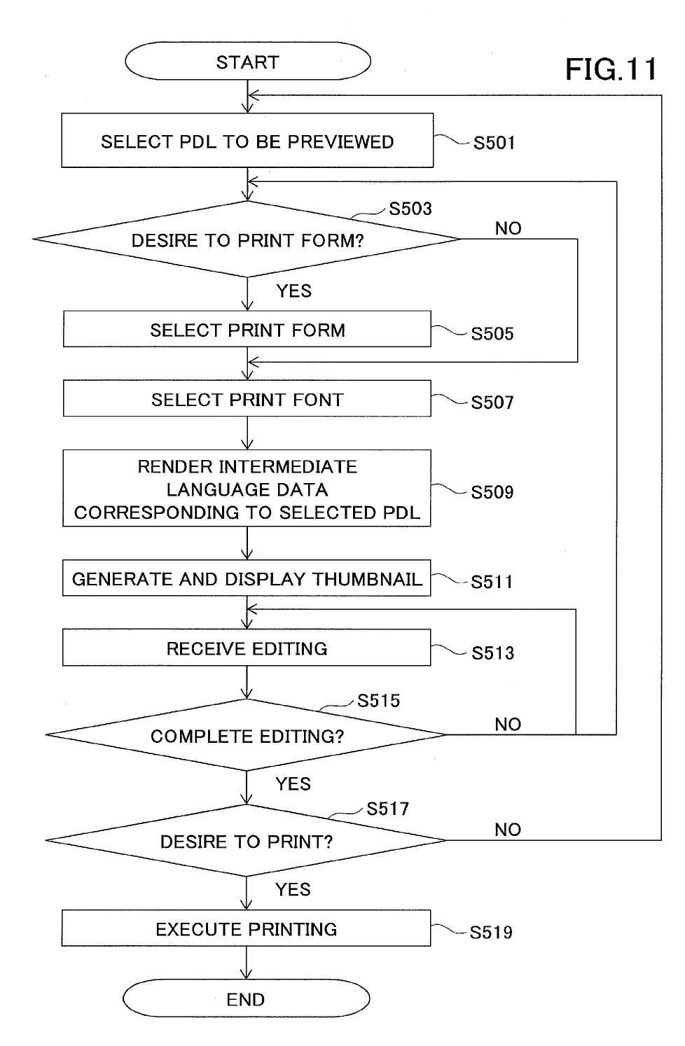

FIG. 11 is a flowchart illustrating an example of a process of the information processing apparatus from editing the intermediate language data to printing the edited intermediate language data.

In step S501, the receiver unit 210 receives the PDL to display print images from the user via the operations panel 105. Note that when the number of intermediate language data sets received from the terminal 20 is one, step S501 may be skipped. For example, as illustrated in FIG. 8, when one intermediate language data set is transmitted to the terminal 20, the number of the intermediate language data sets that allows the information processing apparatus 10 to receive may be one. In such a case, step S501 to allow the user to select the PDL may be unnecessary.

In step S503, the receiver unit 210 receives a selected result from the user via the operations panel 105 as to whether to select form printing. When the selected result indicates printing the form, step S505 is processed, whereas when the selected result does not indicate printing the form, step S507 is processed.

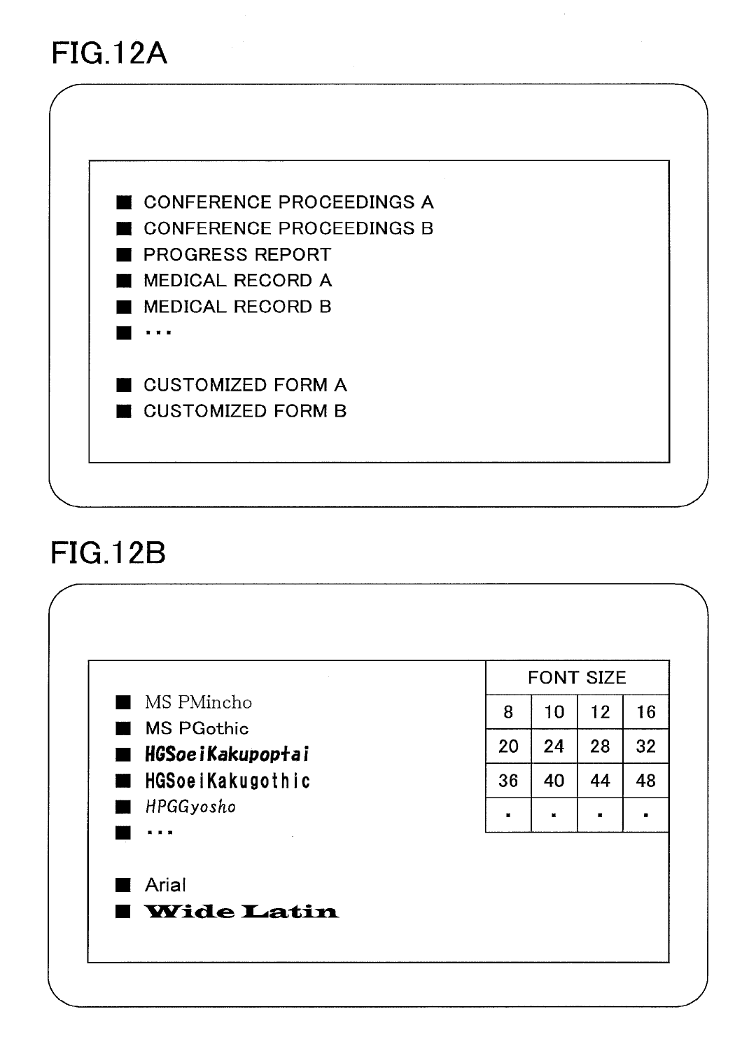

In step S505, the receiver unit 210 receives the selected print form from the user via the operations panel 105. FIG. 12A is an example of a selection screen of print forms.

In step S507, the sample display unit 209 receives the selected print font from the user via the operations panel 105. FIG. 12B is an example of a selection screen of print fonts.

In step S509, the sample display unit 209 rasterizes the intermediate language data corresponding to the PDL selected in step S501, the print form selected in step S505, and the print font selected in step S507 while overlaying the selected intermediate language data, the selected print form, and the selected print font to load the print image in the memory 108.

In step S511, the sample display unit 209 performs a thinning process and a reduction process on the print image to generate thumb nails according to the resolution displayed on the operations panel 105, and causing the operations panel 105 to display the generated thumbnails.

In step S513, the receiver unit 210 receives the edited print form from the user via the operations panel 105. The receiver unit 210 reports the edited content received from the user to the editor unit 206. The editor unit 206 reflects the edited content to the intermediate language data, and stores the edited content reflected intermediate language data in the temporary storage unit 203.

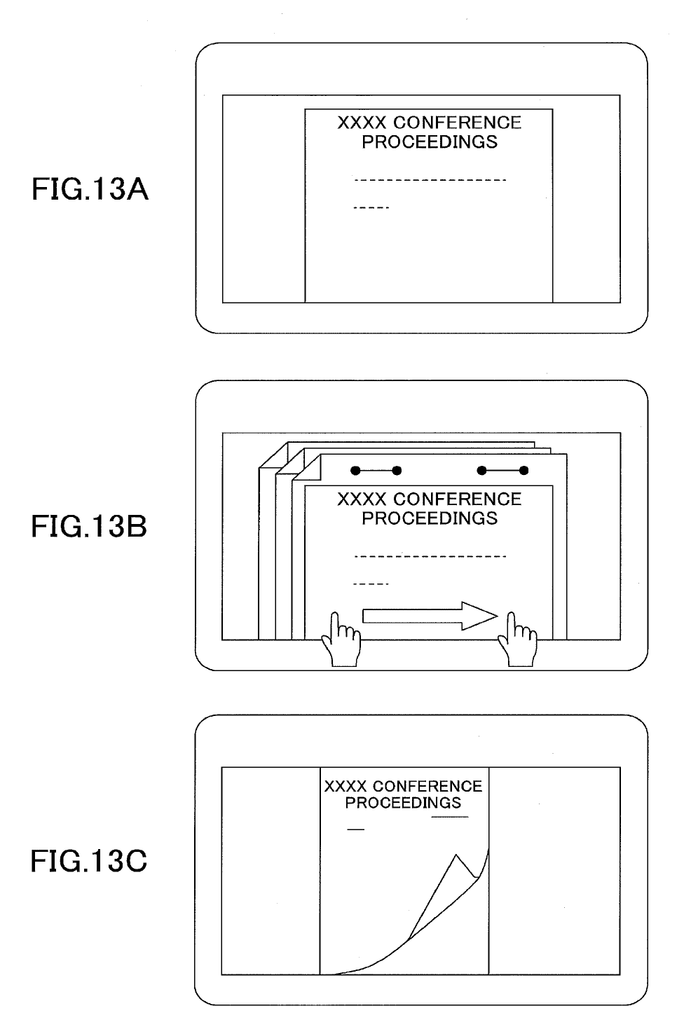

FIG. 13A is an example of a screen displaying a print image before being edited. FIG. 13B is an example of a screen displaying the print image while editing. The user may be able to select the characters subject to editing by dragging a desired part of the operations panel 105. FIG. 13C is an example of a screen displaying the print image after being edited. Note that the user may be able to enlarge or reduce the print image by performing a pinch-out or pinch-in operation on a screen of the operations panel 105 as illustrated in FIGS. 13A, 13B, and 13C. Further, when there are two or more pages of the print images, the user may swipe the screen of the operations panel 105 to turn over the pages of the print images.

In step S515, when the receiver unit 210 receives via the operations panel 105 an instruction indicating the editing is completed, step S517 is processed. When the receiver unit 210 receives via the operations panel 105 an instruction indicating the editing is continued, step S503 or step S513 is processed in accordance with the user's operation.

In step S517, when the receiver unit 210 receives via the operations panel 105 an instruction to start printing, step S519 is processed. When the receiver unit 210 receives via the operations panel 105 an instruction not to proceed with printing, step S501 is processed. Note that when the receiver unit 210 receives the instruction not to proceed with printing, the process may end.

In step S519, the printer unit 207 rasterizes the intermediate language data edited in step S513, the print form selected in step S505, and the print font selected in step S507 while overlaying the edited intermediate language data, the selected print form, and the selected print font to generate a print image. The printer unit 207 transmits the generated print data to the printer module 112 to perform printing.

The above description illustrates the process from displaying (previewing) the print image of the intermediate language data to receiving the editing and printing the edited print image; however, a part of or all of the process in steps S503 to S517 may be omitted. This is because the user does not necessarily desire to preview or edit the print image.

Next, a description is given of modification is configured to read out loud the characters to be printed with sound when the intermediate language data are to be printed.

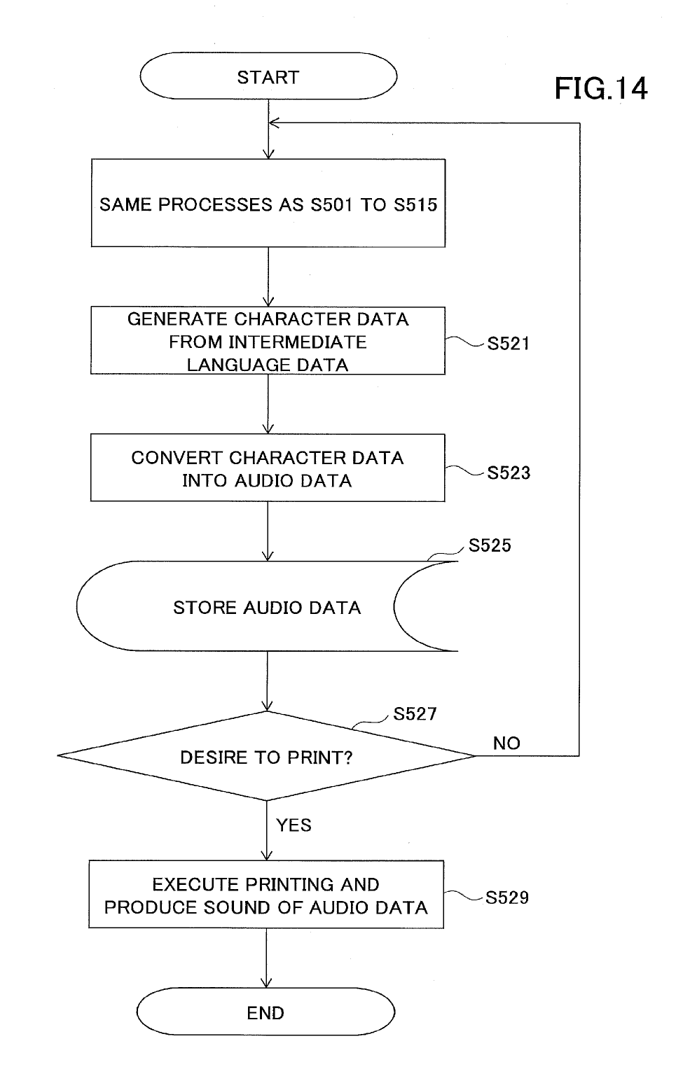

FIG. 14 is a flowchart illustrating a modified example of a process of the information processing apparatus to print the intermediate language data. An illustration of steps S501 to S515 in FIG. 14 is omitted from the specification since steps S501 to S515 are identical to steps S501 to S515 in FIG. 11.

In step S521, the generator unit 205 reads the intermediate language data from the temporary storage unit 203 to generate character data. The intermediate language data are the data before being rasterized, and thus include text characters to be printed. Hence, the generator unit 205 may be able to generate the character data from the intermediate language data.

In step S523, the converter unit 204 converts the character data generated in step S521 into audio data to be read out loud (hereinafter also called “reading audio data”). Note that the converter unit 204 may convert the character data into the reading audio data by accessing an external cloud server or the like via the communications unit 201 to utilize the API provided from the service provider.

In step S525, the converter unit 204 stores the converted reading audio data in the temporary storage unit 203.

In step S527, when the receiver unit 210 receives via the operations panel 105 an instruction to start printing, step S529 is processed. When the receiver unit 210 receives via the operations panel 105 an instruction not to proceed with printing, step S501 is processed. Note that when the receiver unit 210 receives the instruction not to proceed with printing, the process may end.

In step S529, the printer unit 207 rasterizes the intermediate language data edited in step S513, the print form selected in step S505, and the print font selected in step S507 while overlaying the edited intermediate language data, the selected print form, and the selected print font to generate print data. The printer unit 207 transmits the generated print data to the printer module 112 to perform printing. Further, the audio output unit 208 reads out loud the reading audio data stored in step S525. Note that in step S529, the audio output unit 208 may read out loud the reading audio data stored in step S525 simultaneously with printing, or may read out loud the reading audio data at a desired timing. Moreover, when reading out loud the reading audio data has been completed, the reading audio data may be deleted from the temporary storage unit 203.

The above description has illustrated the process of reading the characters to be printed with sound.

Next, a description is given of a process of reporting the completion of printing to the terminal 20 in order to delete the intermediate language data from the terminal 20 when printing is performed by receiving the intermediate language data from the terminal 20, and a description is also given of a process of generating a print log to store the generated print log in the storage unit 213 when the printing is completed.

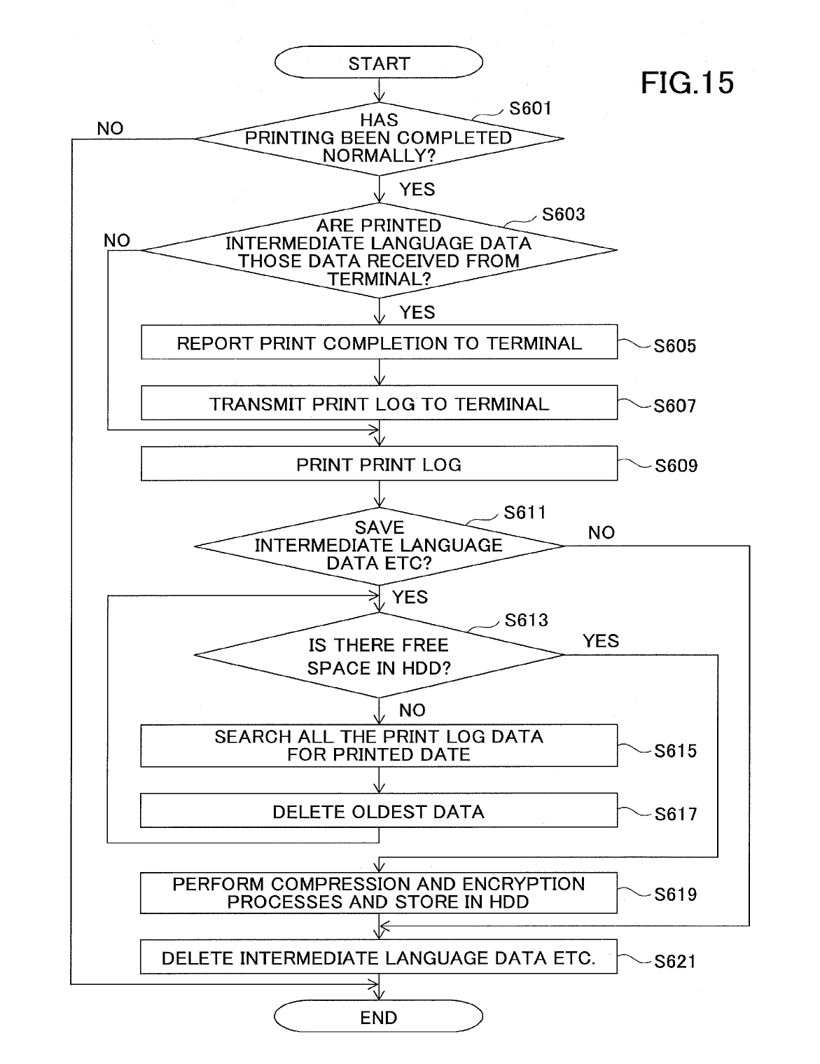

FIG. 15 is a flowchart illustrating an example of a process associated with a process of the information processing apparatus to report completion of the printing and the print log to the terminal. The process of FIG. 15 is activated after step S519 of FIG. 11 or step S529 of FIG. 14 is complete.

In step S601, the printer unit 207 causes the printer module 112 to verify whether the printing has been completed normally. When the printer module 112 verifies that the printing has been completed normally, step S603 is processed, whereas when the printer module 112 fails to verify that the printing has been completed normally, the process ends.

In step S603, the printer unit 207 verifies whether the printed intermediate language data are the data received from the terminal 20. When the printer unit 207 verifies that the printed intermediate language data are the data received from the terminal 20, step S605 is processed, whereas when the printer unit 207 fails to verify that the printed intermediate language data are the data received from the terminal 20, step S609 is processed. Note that in step S413 of FIG. 9, the temporary storage unit 203 records that the intermediate language data are the data received from the terminal 20. Hence, the printer unit 207 may be able to determine whether the printed intermediate language data received via the temporary storage unit 203 are the data received from the terminal 20.

In step S605, the communications unit 201 reports to the terminal 20 that printing of the received intermediate language data has been completed.

In step S607, the printer unit 207 generates a print log, and transmits the generated print log to the terminal 20 via the communications unit 201. Note that the print log indicates print history data with which a history data include additional information such as a printed result, a file name of the printed intermediate language data, file names of the character data and the audio data in association with the intermediate language data, the printed number of pages, a sheet size, selection of monochrome or color, printed date and time, an ID of the terminal connected to the information processing apparatus 10, the ID of the information processing apparatus 10 and/or the location of the information processing apparatus 10. Note that the printer unit 207 stores the print log in the temporary storage unit 203.

In step S609, the printer unit 207 prints the print log generated in step S607. Note that in Step S603, when the printed intermediate language data are not the data received from the terminal 20 (i.e., when the intermediate language data generated by the information processing apparatus 10 itself are printed by the information processing apparatus 10 itself without transmitting the intermediate language data to the terminal 20), the printer unit 207 generate the print log first and subsequently prints the generated print log.

In step S611, the receiver unit 210 causes the operations panel 105 to display a selection screen for allowing the user to select whether to store the intermediate language data printed in step S519 of FIG. 11, the audio data in association with the printed intermediate language data, the character data, and the print log in the storage unit 213, and delete those data from the temporary storage unit 203; or whether to delete the intermediate language data printed in step S519 of FIG. 11, the audio data in association with the printed intermediate language data, the character data, and the print log in the storage unit 213 without storing those data. When the user selects storing those data in the storage unit 213, step S613 is processed, whereas when the user selects deleting those data from the temporary storage unit 203 without storing those data in the storage unit 213, step S621 is processed.

In step S613, the entering unit 212 verifies whether the storage unit 213 has free space (capacity) for storing the intermediate language data printed in step S519 of FIG. 11, the audio data in association with the printed intermediate language data, the character data, and the print log. When the storage unit 213 has a free space, step S619 is processed, whereas when the storage unit 213 does not have a free space, step S615 is processed.

In step S615, the entering unit 212 searches for all the print logs stored in the storage unit 213.

In step S617, the deleting unit 211 deletes the oldest print log among the print logs stored in the storage unit 213, the audio data in association with the oldest print log, the character data, and the intermediate language data.

In step S619, the entering unit 212 performs a compression process and an encryption process on the intermediate language data printed in step S519 of FIG. 11, the audio data in association with the printed intermediate language data, the character data, and the print log, and stores the compressed and encrypted result in the storage unit 213.

Note that when the printed intermediate language data are the intermediate language data generated by another information processing apparatus 10 (i.e., when the intermediate language data generated by another information processing apparatus 10 are received via the terminal 20), the audio data and the character data in association with the printed intermediate language data may not be present in the temporary storage unit 203. In such a case, the entering unit 212 performs a compression process and an encryption process on the intermediate language data printed in step S519 of FIG. 11, and the print log in association with the printed intermediate language data excluding the audio data and the character data, and stores the compressed and encrypted result in the storage unit 213.

In step S621, the deleting unit 211 deletes the intermediate language data printed in step S519 of FIG. 11, the audio data in association with the printed intermediate language data, the character data, and the print log from the temporary storage unit 203.

The above description has illustrated the process of reporting the completion of printing to the terminal 20, and the process of generating a print log to store the generated print log in the storage unit 213 when the printing is completed.

As described above, the information processing apparatus 10 according to the embodiment is configured to receive audio data recorded in the terminal 20 and convert the received audio data into character data. Further, the information processing apparatus 10 is configured to generate intermediate language data corresponding to a PDL interpretable by the information processing apparatus 10 based on the character data to print the generated intermediate language data as well as transmitting the intermediate language data to the terminal 20. Moreover, the information processing apparatus 10 according to the embodiment is configured to display a print image of the intermediate language data on the operations panel 105, and receive an editing operation with respect to the print image displayed on the operations panel 105. With this configuration, when printing is performed by converting the audio data recorded by the terminal 20 into the character data, the user may be able to perform printing after previewing the print image and optionally editing the print image. In addition, the user may be able to move the intermediate language data to another information processing apparatus 10 via the terminal 20, and edit or print the intermediate language data via the other information processing apparatus 10.

Moreover, the information processing apparatus 10 according to the embodiment is configured to allow the user to select a desired one of the PDLs in step S501. Since the appearance (the layout and the like of characters and images) of the printed matter differ according to the selected one of the PDLs corresponding to the intermediate language data, the user may be able to preview the print image with a desired PDL and perform printing.

Further, the information processing apparatus 10 according to the embodiment is configured to read out loud the characters of the printed matter with sound when printing. With this configuration, the user may be able to check the characters to be printed on the printed matter via sound.

Further, the information processing apparatus 10 according to the embodiment is configured to transmit to the terminal 20 only the intermediate language data corresponding to the PDL selected by the user from all the PDLs interpretable by the information processing apparatus 10. With this configuration, the information processing apparatus 10 according to the embodiment may be able to keep the memory space necessary for the information processing apparatus 10 to generate the intermediate language data, the data amount to be processed, and the processing time to the minimum. With this configuration, the user may be able to transmit the intermediate language data corresponding to the PDL selected by the user (the PDL desired by the user) to the terminal 20, and edit or print the intermediate language data by using another information processing apparatus 10.

In addition, the information processing apparatus 10 according to the embodiment is configured to transmit the print log to the terminal 20 after the print log is printed. Further, the information processing apparatus 10 according to the embodiment is configured to delete the print log, the audio data in association with the print log, the intermediate language data and the like from the memory, and compress and encrypt the print log, the audio data in association with the print log, the intermediate language data and the like to be stored in the HDD. With this configuration, the information processing apparatus 10 according to the embodiment may be able to store the print log and the data in association with the print log while reducing the memory space (the memory amount).

### Supplementary Explanation

The present invention is not limited to the embodiments and modification described above, and various alternation and modification may be made within the scope of the present invention.

The order or arrangement of the processes illustrated in the sequences or flowcharts illustrated in the embodiments and modification may be changed insofar as the changed order or arrangement is compatible to the embodiments or modification.

Note that all of or part of the above-described embodiments and modification may be implemented by a computer program. The computer program may be stored in a recording medium.

The disclosed technology may provide functions for converting the audio data into the character data to print the converted result, which may further improves the convenience of the related art technology.

Note that in the above embodiments and modification, the PDL is an example of a print language. The audio output unit 208 is an example of an output unit. The sample display unit 209 is an example of a display unit. The terminal 20 is an example of a predetermined terminal or a terminal differing from the predetermined terminal. The print image is an example of a print sample. The temporary storage unit 203 is an example of a first storage. The storage unit 213 is an example of a second storage.

The present invention is not limited to the specifically disclosed embodiments, and variations and modifications may be made without departing from the scope of the present invention.

The present application is based on and claims the benefit of priority of Japanese Priority Application No. 2014-247323 filed on Dec. 5, 2014, and Japanese Priority Application No. 2015-093465 filed on Apr. 30, 2015, the entire contents of which are hereby incorporated herein by reference.

What is claimed is:

1. An information processing apparatus performing communications with a terminal via a network, the information processing apparatus comprising:
a receiver configured to receive first audio data from a predetermined terminal;
a converter configured to convert the first audio data into first character data;
a generator configured to generate intermediate language data corresponding to a print language interpretable by the information processing apparatus based on the first character data; and
a transmitter configured to transmit the intermediate language data to the predetermined terminal to allow another information processing apparatus to utilize the intermediate language data.

2. The information processing apparatus as claimed in claim 1, wherein
the generator generates the intermediate language data that are specified by a user.

3. The information processing apparatus as claimed in claim 1, further comprising:
a first storage configured to store the intermediate language data, wherein
the receiver receives the intermediate language data from a terminal differing from the predetermined terminal, and
the first storage stores the received intermediate language data when the received intermediate language data correspond to the print language interpretable by the information processing apparatus.

4. The information processing apparatus as claimed in claim 3, further comprising:
a display unit configured to generate a print sample for printing the intermediate language data, and display the generated print sample; and
a printer unit configured to print the intermediate language data.

5. The information processing apparatus as claimed in claim 4, further comprising:
an editor unit configured to edit the intermediate language data stored in the first storage based on an instruction from a user.

6. The information processing apparatus as claimed in claim 4, further comprising:
an output unit configured to output sound, wherein
the generator generates second character data based on the intermediate language data,
the converter converts the second character data into second audio data, and
the output unit outputs sound by reading out loud the second audio data.

7. The information processing apparatus as claimed in claim 4, wherein
when printing the intermediate language data received from the terminal differing from the predetermined terminal has been completed, the transmitter reports to the terminal differing from the predetermined terminal that the printing of the intermediate language data has been completed.

8. The information processing apparatus as claimed in claim 7, wherein
the printer unit generates a print log when the printing of the intermediate language data received from the terminal differing from the predetermined terminal has been completed, prints the generated print log, and stores the generated print log in the first storage, and
the transmitter transmits the print log to the terminal differing from the predetermined terminal.

9. The information processing apparatus as claimed in claim 8, further comprising:
a deleting unit configured to delete from the first storage the intermediate language data the printing of which has been completed, and the print log.

10. The information processing apparatus as claimed in claim 8, further comprising:
an entering unit configured to compress and encrypt one of the first audio data, the first character data, the intermediate language data the printing of which has been completed, and the print log, and store the compressed and encrypted one of the first audio data, the first character data, the intermediate language data the printing of which has been completed, and the print log in the second storage, based on an instruction from a user.

11. The information processing apparatus as claimed in claim 10, wherein
when the entering unit fails to store the compressed and encrypted one of the first audio data, the first character data, the intermediate language data the printing of which has been completed, and the print log in the second storage, the entering unit deletes an oldest one of the first audio data, the first character data, the intermediate language data the printing of which has been completed, and the print log.

12. A method for processing information in an information processing apparatus performing communications with a terminal via a network, the method comprising:
receiving audio data from a predetermined terminal;
converting the audio data into character data;
generating intermediate language data corresponding to a print language interpretable by the information processing apparatus based on the character data; and
transmitting the intermediate language data to the predetermined terminal to allow another information processing apparatus to utilize the intermediate language data.
